(19) United States
(12) Patent Application Publication
(10) Pub. No.: US 2021/0048582 A1
(43) Pub. Date: Feb. 18, 2021

(54) OPTICAL DEVICE

(71) Applicant: FUJIKURA LTD., Tokyo (JP)

(72) Inventors: Keisuke Uchiyama, Chiba (JP); Masahiro Kashiwagi, Chiba (JP); Kensuke Shima, Chiba (JP)

(73) Assignee: FUJIKURA LTD., Tokyo (JP)

(21) Appl. No.: 16/978,444

(22) PCT Filed: Mar. 15, 2019
(86) PCT No.: PCT/JP2019/010804

§ 371 Date: Sep. 4, 2020

(30) Foreign Application Priority Data
Mar. 16, 2018 (JP) 2018-049884

(51) Int. Cl. G02B 6/255

(52) U.S. Cl. CPC G02B 6/2558

(57) ABSTRACT

An optical device includes: a thermal conductor; a support that is separated from the thermal conductor and that has a coefficient of thermal expansion lower than a coefficient of thermal expansion of the thermal conductor; and an optical fiber that thermally contacts with the thermal conductor via a resin covering a jacket-removed section of the optical fiber and that is fixed to the support in each of two jacketed sections of the optical fiber, wherein the two jacketed sections are adjacent to the jacket-removed section.

### TECHNICAL FIELD

The present invention relates to an optical device including (i) an optical fiber which has a jacket-removed section and (ii) a reinforcing structure which reinforces the jacket-removed section.

### BACKGROUND

Optical fibers often have jacket-removed sections. In an optical fiber, a jacket-removed section indicates a section in which a jacket made of resin is removed and a cladding made of glass is exposed. For example, in a case where two optical fibers are fusion-spliced, a jacket-removed section is provided at and in a vicinity of a fusion-spliced point. Further, cladding mode strippers for removing cladding mode light from optical fibers also have jacket-removed sections.

The jacket-removed sections are inferior in mechanical strength to the other sections. Therefore, various reinforcing structures which reinforce the jacket-removed sections are employed. For example, Patent Literatures 1 and 2 each disclose a reinforcing structure which reinforces a jacket-removed section.

### PATENT LITERATURE

### Patent Literature 1

Japanese Patent Application Publication Tokukai No. 2008-187100 (Publication date: Aug. 14, 2008)

### Patent Literature 2

Japanese Patent Application Publication Tokukai No. 2011-211220 (Publication date: Oct. 20, 2011)

FIGS. 4A-4B illustrate a typical optical device 4 including (i) an optical fiber which has a jacket-removed section and (ii) a reinforcing structure which reinforces the jacket-removed section. FIG. 4A is a plan view of the optical device 4, and FIG. 4B is a cross-sectional view of the optical device 4. Note that the cross-sectional view in FIG. 4B illustrates a cross section as viewed along arrows AA' illustrated in FIG. 4A.

In the optical device 4, an optical fiber OF is fixed to a reinforcing plate 42 attached to an upper surface of a heat sink 41. Specifically, a jacketed section Ib1 which is one of jacketed sections adjacent to a jacket-removed section Ia is fixed to the reinforcing plate 42 with use of an adhesive 45, and a jacketed section Ib2 which is the other of the jacketed sections adjacent to the jacket-removed section Ia is fixed to the reinforcing plate with use of an adhesive 46. This allows mechanical reliability of the optical fiber OF to be ensured.

The jacket-removed section Ia of the optical fiber OF is covered with a resin member 44 having thermal conductivity.

Heat generated in the jacket-removed section Ia of the optical fiber OF is conducted to the reinforcing plate 42 through the resin member 44, and is further conducted to the heat sink 41 through reinforcing plate 42. This suppresses a rise in temperature of the optical fiber OF.

However, the optical device 4 has the following issue. That is, in a case where heat generated in the jacket-removed section Ia of the optical fiber OF is conducted as described above, a temperature of the reinforcing plate 42 rises. This causes thermal expansion of the reinforcing plate 42. As a result, tension acts on the optical fiber OF via the adhesives 45 and 46. This causes loss of the mechanical reliability of the optical fiber OF.

### SUMMARY

One or more embodiments of the present invention provide an optical device in which a rise in temperature of an optical fiber is suppressed while mechanical reliability of the optical fiber is ensured.

An optical device in accordance with one or more embodiments of the present invention includes: a thermal conductor; a support which is separate from the thermal conductor and which has a coefficient of thermal expansion lower than a coefficient of thermal expansion of the thermal conductor; and an optical fiber which is in thermal contact with the thermal conductor via a resin member (i.e., resin) covering a jacket-removed section and which is fixed to the support in each of two jacketed sections adjacent to the jacket-removed section.

According to one or more embodiments of the present invention, it is possible to realize an optical device in which a rise in temperature of an optical fiber is suppressed while mechanical reliability of the optical fiber is ensured.

### BRIEF DESCRIPTION OF DRAWINGS

FIGS. 1A-1B are drawings illustrating an optical device in accordance with one or more embodiments of the present invention. FIG. 1A is a plan view of the optical device. FIG. 1B is a cross-sectional view of the optical device.

FIG. 2 is a plan view illustrating Variation 1 of the optical device illustrated in FIGS. 1A- 1B.

FIG. 3 is a cross-sectional view illustrating Variation 2 of the optical device illustrated in FIGS. 1A-1B.

FIGS. 4A-4B are drawings illustrating a conventional optical device. FIG. 4A is a plan view of the conventional optical device. FIG. 4B is a cross-sectional view of the conventional optical device.

### DETAILED DESCRIPTION

[Configuration of Optical Device]

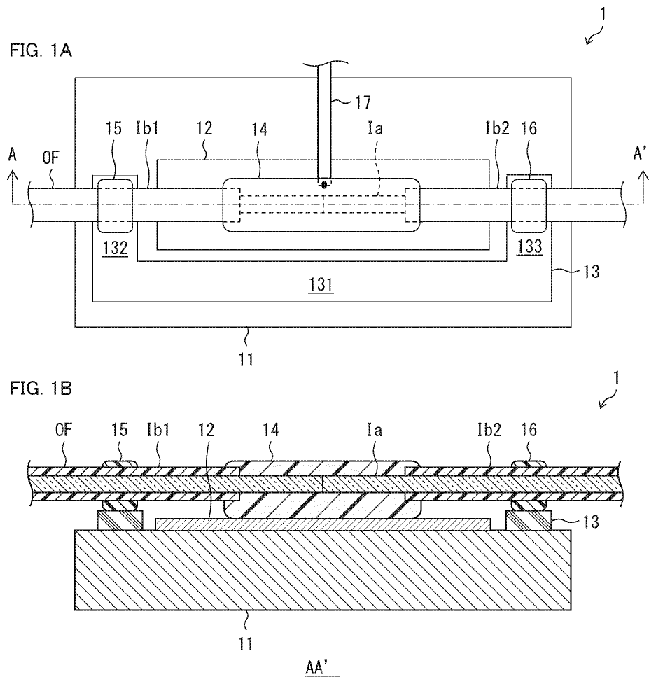

A configuration of an optical device 1 in accordance with one or more embodiments of the present invention will be described with reference to FIGS. 1A-1B. FIG. 1A is a plan view of the optical device 1, and FIG. 1B is a cross-sectional view of the optical device 1. Note that the cross-sectional view in FIG. 1B illustrates a cross section as viewed along arrows AA′ illustrated in FIG. 1A.

As illustrated in FIGS. 1A-1B, the optical device 1 includes an optical fiber OF, a heat sink 11, a thermal conductor 12, a support 13, a resin member 14, an adhesive 15, and an adhesive 16. Note that the thermal conductor 12 and the support 13, both of which are provided on an upper surface of the heat sink 11, are separate members.

The optical fiber OF is constituted by two optical fibers which are fusion-spliced, and includes a fusion-spliced point. The fusion-spliced point of the optical fiber OF and a vicinity thereof constitute a jacket-removed section Ia in which a jacket is removed. Hereinafter, one of sections each of which is adjacent to the jacket-removed section Ia and in each of which the jacket remains will be referred to as a first jacketed section Ib1, and the other will be referred to as a second jacketed section Ib2. Further, the first jacketed section Ib 1 and the second jacketed section Ib2 will be collectively referred to as jacketed sections Ib1 and Ib2.

The heat sink 11 is a structure for diffusing, outward, heat which has been conducted to the heat sink 11 through the thermal conductor 12 (later described), among heat which has been generated at and in the vicinity of the fusion-spliced point of the optical fiber OF. In one or more embodiments, a copper body having a shape of a rectangular parallelepiped is used as the heat sink 11. Note that a material of the heat sink 11 is not limited to copper, and only needs to be a material having a high thermal conductivity. Examples of a material, other than copper, of the heat sink 11 include an aluminum alloy. Note also that a fin or the like (not illustrated) can be provided on a lower surface of the heat sink 11. Instead of the heat sink 11, a water-cooling plate can be alternatively used.

The thermal conductor 12 is a structure for conducting, to the heat sink 11, heat which has been conducted to the thermal conductor 12 through the resin member 14 (later described), among heat which has been generated at and in the vicinity of the fusion-spliced point of the optical fiber OF. In one or more embodiments, an aluminum plate (plate-shaped member made of aluminum or an aluminum alloy) which is attached to the upper surface of the heat sink 11 and which has a rectangular shape is used as the thermal conductor 12. Note that, in one or more embodiments, as a material of the thermal conductor 12, a material which has a thermal conductivity and a coefficient of thermal expansion that are higher than those of a material of the support 13 (later described) is used. Aluminum and an aluminum alloy are examples of a material which satisfies such conditions, and any other material, for example, copper can be alternatively used.

The support 13 is a structure for supporting the optical fiber OF. In one or more embodiments, as the support 13, a ceramic body is used which has an arc shape in a plan view and which is obtained by combining three rectangular parallelepipeds (a first rectangular parallelepiped 131, a second rectangular parallelepiped 132, and a third rectangular parallelepiped 133) in a U-shape or a C-shape. The support 13 is disposed so that the first rectangular parallelepiped 131 extends along the optical fiber OF and each of the second rectangular parallelepiped 132 and the third rectangular parallelepiped 133 overlaps the optical fiber OF. In other words, the support 13 has, in a plan view, such a shape that the support 13 surrounds the thermal conductor 12 on three sides and part of the support 13 which part corresponds to the other side of the thermal conductor 12 is opened. As used herein, an arc shape includes (1) a shape which is illustrated in FIG. 1A and in which a connection between the first rectangular parallelepiped 131 and the second rectangular parallelepiped 132 and a connection between the first rectangular parallelepiped 131 and the third rectangular parallelepiped 133 each form a corner, (2) a U-shape in which the connection between the first rectangular parallelepiped 131 and the second rectangular parallelepiped 132 and the connection between the first rectangular parallelepiped 131 and the third rectangular parallelepiped 133 are each formed so as to have a curved line, and (3) a C-shape which is obtained by opening part of a ring. Note, however, that the first through third rectangular parallelepipeds 131 through 133 of the support 13 are apart from the respective three sides of the thermal conductor 12, and a gap is provided between the support 13 and the thermal conductor 12. This is for preventing contact between the thermal conductor 12 and the support 13 and conduction of heat from the thermal conductor 12 to the support 13, which contact and conduction occur in a case where thermal expansion of the thermal conductor 12 occurs.

Note that, in one or more embodiments, as the material of the support 13, a material which has a thermal conductivity and a coefficient of thermal expansion that are lower than those of the material of the thermal conductor 12 is used. Ceramic is an example of a material which satisfies such conditions, and any other material, for example, glass can be alternatively used. Note also that the support 13 only needs to be placed on the upper surface of the heat sink 11 and does not always need to be fixed to the upper surface of the heat sink 11.

As has been described, the support 13 of the optical device 1 only needs to be apart from the thermal conductor 12 and surround the thermal conductor 12 on the three sides. Therefore, the optical device 1 has an advantage that the optical device 1 is easily reduced in size in a plan view as illustrated in FIG. 1A.

Furthermore, according to the optical device 1, the support 13 is provided on the upper surface of the heat sink 11. Therefore, the optical device 1 has an advantage that the optical device 1 is easily reduced in size in a side view.

The jacket-removed section Ia of the optical fiber OF is covered with the resin member 14, and is in thermal contact with the thermal conductor 12 via the resin member 14. Therefore, heat generated in the optical fiber OF is conducted to the thermal conductor 12 through the resin member 14.

In one or more embodiments, a soft silicone resin member is used as the resin member 14. Note that a material of the resin member 14 may be thermally conductive resin which has a Young's modulus lower than that of a material of each of the adhesives 15 and 16 (later described) and which has an ultimate elongation percentage higher than that of the material of each of the adhesives 15 and 16. Soft silicone resin is an example of resin which satisfies such conditions, and any other resin, for example, rubber can be alternatively used. In a case where, in the jacket-removed section Ia, light is caused to leak from the optical fiber OF, transparent resin, which has a refractive index higher than that of an outermost shell (for example, a cladding), may be used in the jacket-removed section Ia, of the optical fiber OF. In contrast, in a case where, in the jacket-removed section Ia, light is caused not to leak from the optical fiber OF, transparent or non-transparent resin which has a refractive index lower than that of the outermost shell, in the jacket-removed section Ia, of the optical fiber OF can be used.

Note that, in one or more embodiments, a configuration is employed in which a range of the optical fiber OF which range is covered with the resin member 14 is broaden to a range which includes the first jacketed section Ib 1 and the second jacketed section Ib2. Note, here, that the first jacketed section Ib1 and the second jacketed section Ib are adjacent to respective ends of the jacket-removed section Ia. Note also that, in one or more embodiments, a configuration is employed in which an area of contact between the resin member 14 and the optical fiber OF and an area of contact between the resin member 14 and the thermal conductor 12 are increased. This makes it possible to more efficiently conduct, to the thermal conductor 12, heat generated at and in the vicinity of the fusion-spliced point of the optical fiber OF.

According to the optical device 1, the first jacketed section Ib1, which is adjacent to the jacket-removed section Ia, is fixed to an upper surface of the second rectangular parallelepiped 132 of the support 13 with use of the adhesive 15. According to the optical device 1, the second jacketed section Ib2, which is adjacent to the jacket-removed section Ia, is fixed to an upper surface of the third rectangular parallelepiped 133 of the support 13 with use of the adhesive 16. In one or more embodiments, a hard silicone resin member is used as each of the adhesives 15 and 16. Note that the material of each of the adhesives 15 and 16 may be resin which has a Young's modulus higher than that of the material of the resin member 14 and which has an ultimate elongation percentage lower than that of the material of the resin member 14. Hard silicone resin is an example of resin which satisfies such conditions, and any other resin can be alternatively used.

According to the optical device 1 configured as described above, heat generated at and in the vicinity of the fusion-spliced point of the optical fiber OF is (1) conducted to the thermal conductor 12 through the resin member 14, (2) conducted to the heat sink 11 through the thermal conductor 12, and (3) dissipated outward through the heat sink 11. Alternatively, heat generated at and in the vicinity of the fusion-spliced point of the optical fiber OF is (1) conduced to the adhesives 15 and 16 through the jacket of the optical fiber OF, (2) conducted to the support 13 through the adhesives 15 and 16, (3) conducted to the heat sink 11 through the support 13, and (4) dissipated outward through the heat sink 11.

In this manner, heat generated at and in the vicinity of the fusion-spliced point of the optical fiber OF can be conducted to both of the thermal conductor 12 and the support 13. Note, however, that the coefficient of thermal expansion of the support 13 is lower than that of the thermal conductor 12. Therefore, tension which acts on the optical fiber OF from the support 13 in the optical device 1 is smaller than tension which acts on the optical fiber OF from the reinforcing plate 42 (corresponding to the thermal conductor 12 of the optical device 1) in the conventional optical device 4.

Moreover, according to the optical device 1 in accordance with one or more embodiments, a configuration is employed in which the thermal conductivity of the thermal conductor 12 is higher than that of the support 13. Therefore, most of heat generated at and in the vicinity of the fusion-spliced point of the optical fiber OF is dissipated outward along the above-described conduction path including the thermal conductor 12. Thus, a rise in temperature of the thermal conductor 12 due to heat generated at and in the vicinity of the fusion-spliced point of the optical fiber OF is prone to occur, while a rise in temperature of the support 13 due to heat generated at and in the vicinity of the fusion-spliced point of the optical fiber OF is less prone to occur.

This allows the above effect to be more remarkably brought about. Note that the configuration in which the thermal conductivity of the thermal conductor 12 is higher than that of the support 13 may be a configuration which makes the above effect remarkable, but is not a configuration essential to bring about the above effect. That is, it is not always necessary to employ the configuration in which the thermal conductivity of the thermal conductor 12 is higher than that of the support 13, provided that a degree of the effect does not matter.

Furthermore, according to the optical device 1 in accordance with one or more embodiments, a configuration is employed in which a heat source (the fusion-spliced point and the vicinity thereof) is included in the jacket-removed section Ia. That is, according to the optical device 1, a configuration is employed in which, in the jacket-removed section Ia including the heat source, the optical fiber OF is in thermal contact with the thermal conductor 12 via the resin member 14. Meanwhile, according to the optical device 1, a configuration is employed in which, in the jacketed sections Ib 1 and Ib2 each including no heat source, the optical fiber OF is fixed to the support 13 via the adhesives 15 and 16, respectively. Further, according to the optical device 1 in accordance with one or more embodiments, a configuration is employed in which the support 13 is apart from the thermal conductor 12. Therefore, a rise in temperature of the support 13 is even less prone to occur, so that thermal expansion of the support 13 is even less prone to occur. This allows the above effect to be more remarkably brought about.

Note that the configuration in which the fusion-spliced point (and the vicinity thereof) serving as the heat source is included in the jacket-removed section Ia and the configuration in which the support 13 is apart from the thermal conductor 12 may be configurations which make the above effect remarkable, but are not configurations essential to bring about the above effect. That is, it is not always necessary to employ the configuration in which the heat source is included in the jacket-removed section Ia and the configuration in which the support 13 is apart from the thermal conductor 12, provided that the degree of the effect does not matter.

Note that tension which acts on the optical fiber OF via the resin member 14 due to thermal expansion of the thermal conductor 12 is much smaller than tension which acts on the optical fiber OF via each of the adhesives 15 and 16 due to thermal expansion of the support 13. This is because the resin member 14 is made of resin which has a Young's modulus lower than that of the material of each of the adhesives 15 and 16. Therefore, tension which acts on the optical fiber OF in the optical device 1 is smaller than tension which acts on the optical fiber OF in the conventional optical device 4, even in consideration of the tension which acts on the optical fiber OF via the resin member 14 due to the thermal expansion of the thermal conductor 12.

Note that the optical device 1 can further include a thermocouple 17 embedded in the resin member 14, as illustrated in FIG. 1A. In a case where the optical device 1 is used as, for example, part of a fiber laser, a temperature measured by the thermocouple 17 is fed back to a control section of the fiber laser. This allows the control section of the fiber laser to control an output of the fiber laser so that, for example, a temperature of the resin member 14 does not excessively rise.

[Variation 1 of Optical Device]

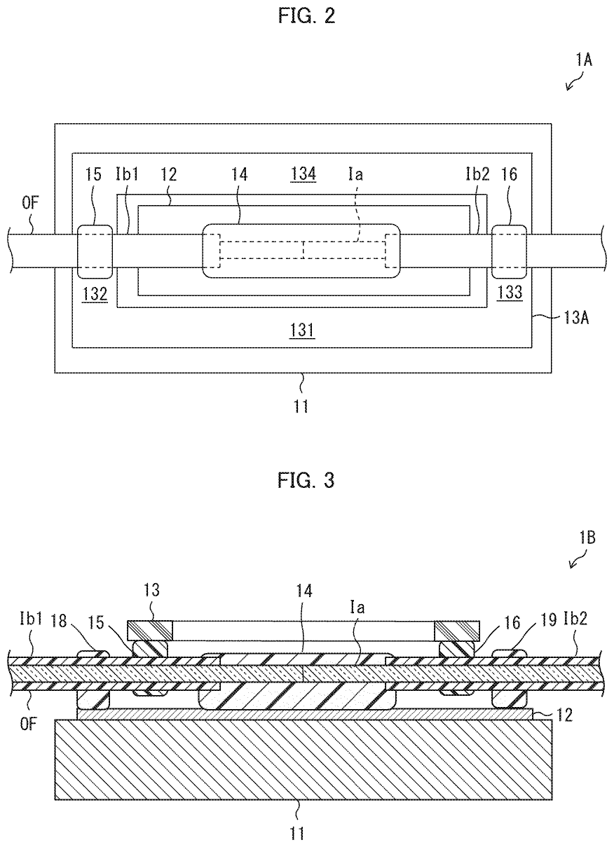

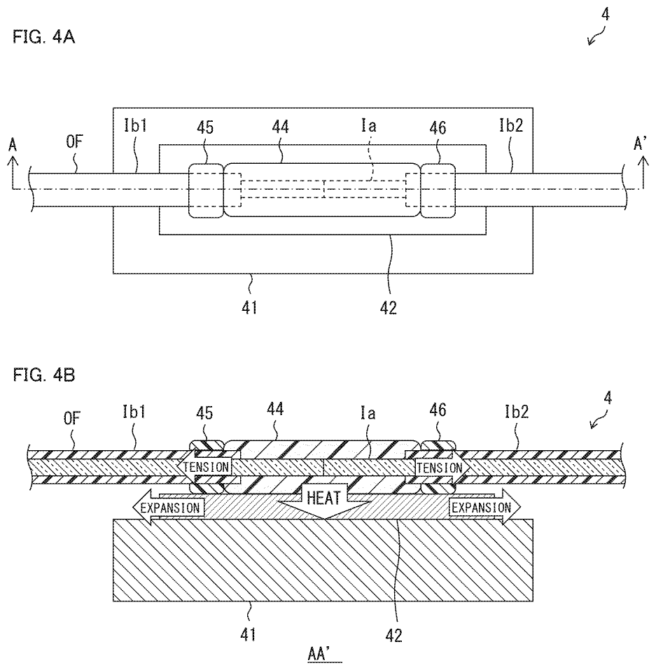

Next, Variation 1 (hereinafter, referred to as an optical device 1A) of the optical device 1 will be described with reference to FIG. 2. FIG. 2 is a plan view of the optical device 1A.

The optical device 1A is different from the optical device 1 in the following points. That is, as illustrated in FIG. 1A, the optical device 1 is configured such that the support 13, which has an arc shape in a plan view and which is obtained by combining the first through third rectangular parallelepipeds 131 through 133, surrounds the thermal conductor 12 on the three sides. In contrast, the optical device 1A includes a fourth rectangular parallelepiped 134 as a rectangular parallelepiped, as illustrated in FIG. 2. The optical device 1A is configured such that a support 13A, which has a closed ring shape in a plan view and which is obtained by combining first through fourth rectangular parallelepipeds 131 through 134, surrounds a thermal conductor 12 on four sides. Note that FIG. 2 illustrates a configuration in which the support 13A passes along a periphery of a rectangle which has a fusion-spliced point of an optical fiber OF as a center. Instead of the configuration, a configuration can be alternatively employed in which the support 13A passes along a periphery of a circle which has the fusion-spliced point of the optical fiber OF as a center.

As has been described, the support 13 of the optical device 1 is smaller in size than the support 13A of the optical device 1A. Therefore, the optical device 1 has an advantage that the optical device 1 is more easily reduced in size in a plan view than the optical device 1A. On the other hand, the support 13A of the optical device 1A is more symmetrical in shape than the support 13 of the optical device 1, and therefore the support 13A is less prone to distort even in a case where thermal expansion of the support 13A occurs. Therefore, the optical device 1A has an advantage that the optical fiber OF is less prone to receive stress, other than tension, from the support 13A, as compared with the optical device 1. Moreover, the support 13A of the optical device 1A is larger in size than the support 13 of the optical device 1, and therefore a temperature of the support 13A is less prone to rise. Thus, the optical device 1A has an advantage that thermal expansion of the support 13A is even less prone to occur.

[Variation 2 of Optical Device]

Next, Variation 2 (hereinafter, referred to as an optical device 1B) of the optical device 1 will be described with reference to FIG. 3. FIG. 3 is a cross-sectional view of the optical device 1B.

The optical device 1B is different from the optical device 1 in the following points. That is, according to the optical device 1, the support 13 is placed on the upper surface of the heat sink 11, as illustrated in FIG. 1B. In contrast, according to the optical device 1B, a support 13 is not placed on an upper surface of a heat sink 11, as illustrated in FIG. 3. Specifically, the support 13 is disposed so as to be located above an optical fiber OF via adhesives 15 and 16 and be located apart from the heat sink 11. In this case, a lower surface of the support 13 is fixed to a first jacketed section Ibl of the optical fiber OF by the adhesive 15. Further, the lower surface of the support 13 is fixed to a second jacketed section Ib2 of the optical fiber OF by the adhesive 16. According to the optical device 1B, the first jacketed section Ib1 of the optical fiber OF is in thermal contact with a thermal conductor 12 via a resin member 18, and the second jacketed section Ib2 of the optical fiber OF is in thermal contact with the thermal conductor 12 via a resin member 19, as illustrated in FIG. 3. Note that the support 13 is fixed to, for example, a lower surface of a lid (not illustrated) of the optical device 1B so that a weight of the support 13 does not act on the optical fiber OF as lateral pressure

As has been described, according to the optical device 1, the support 13 is provided on the upper surface of the heat sink 11. Therefore, the optical device 1 has an advantage that the optical device 1 is more easily reduced in size in a side view than the optical device 1B. On the other hand, according to the optical device 1B, each of the first jacketed section Ib1 and the second jacketed section Ib2 of the optical fiber OF is in thermal contact with the thermal conductor 12. Therefore, the optical device 1B has an advantage that a temperature of the first jacketed section Ib1 and a temperature of the second jacketed section Ib2 are less prone to rise, as compared with the optical device 1. Moreover, according to the optical device 1B, heat from the optical fiber OF to the thermal conductor 12 is conducted downward, while heat from the optical fiber OF to the support 13 is conducted upward. Therefore, the temperature of the support 13 is less prone to rise. Thus, the optical device 1B has an advantage that thermal expansion of the support 13 is even less prone to occur.

One or more embodiments of the present invention can also be expressed as follows:

An optical device (1, 1A, 1B) in accordance with one or more embodiments of the present invention includes: a thermal conductor (12); a support (13, 13A) which is separate from the thermal conductor (12) and which has a coefficient of thermal expansion lower than a coefficient of thermal expansion of the thermal conductor (12); and an optical fiber (OF) which is in thermal contact with the thermal conductor (12) via a resin member (14) covering a jacket-removed section (Ia) and which is fixed to the support (13, 13A) in each of two jacketed sections (Ib1 and Ib2) adjacent to the jacket-removed section (Ia).

According to the above configuration, a heat dissipating function of a reinforcing structure of a conventional optical device is replaced with the thermal conductor, and a reinforcing function of the reinforcing structure of the conventional optical device is replaced with the support. Moreover, according to the above configuration, thermal expansion of the support which has a relatively low coefficient of thermal expansion is smaller than that of the thermal conductor which has a relatively high coefficient of thermal expansion. Therefore, according to the above configuration, it is possible to cause tension which acts on the optical fiber from the support to be smaller than tension which acts on an optical fiber from a reinforcing plate in a conventional optical device. According to the above configuration, it is therefore possible to enhance mechanical reliability of the optical fiber more than a conventional optical device.

The optical device (1) in accordance with one or more embodiments of the present invention may be arranged such that the support (13, 13A) has a thermal conductivity lower than a thermal conductivity of the thermal conductor (12).

According to the above configuration, it is possible to cause a rise in temperature of the support to be even less prone to occur. According to the above configuration, it is therefore possible to further enhance the mechanical reliability of the optical fiber.

The optical device (1, 1A, 1B) in accordance with one or more embodiments of the present invention may be arranged such that the optical fiber (OF) is fixed to the support (13, 13A) with use of an adhesive (15, 16) in each of the two jacketed sections (Ib1, Ib2); and the resin member (14) has a Young's modulus lower than a Young's modulus of the adhesive (15, 16).

According to the above configuration, tension which acts on the optical fiber via the resin member from the thermal conductor due to thermal expansion of the thermal conductor is smaller than tension which acts on the optical fiber via the adhesive from the support due to thermal expansion of the support. Therefore, tension which acts on the optical fiber in the optical device in accordance with one or more embodiments of the present invention is smaller than tension which acts on an optical fiber in a conventional optical device, even in consideration of the tension which acts on the optical fiber via the resin member from the thermal conductor due to the thermal expansion of the thermal conductor.

The optical device (1, 1A, 1B) in accordance with one or more embodiments of the present invention may be arranged such that a gap is provided between the thermal conductor (12) and the support (13, 13A).

According to the above configuration, the thermal conductor is less prone to come into contact with the support in a case where thermal expansion of the thermal conductor occurs.

The optical device (1) in accordance with one or more embodiments of the present invention may be arranged such that the support (13) is a support (131, 132, and 133) which has an arc shape and which surrounds the thermal conductor on three sides.

According to the above configuration, it is easy to reduce a size of the optical device.

The optical device (1A) in accordance with one or more embodiments of the present invention may be arranged such that the support (13A) is a support (131, 132, 133, and 134) which has a ring shape and which surrounds the thermal conductor on four sides.

According to the above configuration, the optical fiber is less prone to receive stress, other than tension.

The optical device (1, 1A, 1B) in accordance with one or more embodiments of the present invention may be arranged such that the optical fiber (OF) includes a fusion-spliced point in the jacket-removed section (Ia).

The fusion-spliced point of the optical fiber serves as a heat source. According to the above configuration, a temperature of the support which is fixed to the optical fiber in each of the jacketed sections is less prone to rise, as compared with the thermal conductor which is in thermal contact with the optical fiber via the resin member in the jacket-removed section that includes the fusion-spliced point serving as a heat source. According to the above configuration, the effect of enhancing the mechanical reliability of the optical fiber is therefore more remarkably brought about.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1, 1A, 1B Optical device

11 Heat sink

12 Thermal conductor

13 Support

131 First rectangular parallelepiped

132 Second rectangular parallelepiped

133 Third rectangular parallelepiped

134 Fourth rectangular parallelepiped

14, 18, 19 Resin member

15, 16 Adhesive

17 Thermocouple

Ia Jacket-removed section

Ib1 First jacketed section

Ib2 Second jacketed section

OF Optical fiber

1. An optical device comprising:
a thermal conductor;
a support that is separated from the thermal conductor and that has a coefficient of thermal expansion lower than a coefficient of thermal expansion of the thermal conductor; and
an optical fiber that thermally contacts the thermal conductor via a resin covering a jacket-removed section of the optical fiber and that is fixed to the support in each of two jacketed sections of the optical fiber, wherein the two jacketed sections are adjacent to the jacket-removed section.

2. The optical device according to claim 1, wherein the support has a thermal conductivity lower than a thermal conductivity of the thermal conductor.

3. The optical device according to claim 1, wherein the optical fiber is fixed to the support via an adhesive in each of the two jacketed sections; and
the resin has a Young's modulus lower than a Young's modulus of the adhesive.

4. The optical device according to claim 1, wherein a gap is disposed between the thermal conductor and the support.

5. The optical device according to claim 1, wherein the support has an arc shape and surrounds three sides of the thermal conductor.

6. The optical device according to claim 1, wherein the support has a ring shape and surrounds four sides of the thermal conductor.

7. The optical device according to claim 1, wherein the optical fiber comprises a fusion-spliced point in the jacket-removed section.
